(19) United States
(12) Patent Application Publication
(10) Pub. No.: US 2014/0265328 A1
(43) Pub. Date: Sep. 18, 2014

(54) ELECTRICITY GENERATING ARRANGEMENT

(71) Applicant: Coenraad Frederik Van Blerk, Boksburg (ZA)

(72) Inventor: Coenraad Frederik Van Blerk, Boksburg (ZA)

(21) Appl. No.: 14/284,243

(22) Filed: May 21, 2014

Related U.S. Application Data
(63) Continuation-in-part of application No. 12/919,297, filed on Aug. 25, 2010, now abandoned.

(30) Foreign Application Priority Data
Feb. 25, 2008 (ZA) 2008/01762

(51) Int. Cl. F03B 13/10

(52) U.S. Cl. CPC F03B 13/10
USPC 290/43

(57) ABSTRACT

An arrangement includes a secondary fluid conduit fitted to a primary fluid conduit which is fitted with a pressure reducing valve, a first isolating valve upstream, and a second isolating valve downstream. The secondary fluid conduit defines an inlet for allowing fluid flowing through the primary fluid conduit to enter the secondary fluid conduit, to define a mode in which all the fluid flows through the secondary fluid conduit, and an outlet for allowing fluid flowing through the secondary fluid conduit to rejoin the primary fluid conduit after the second isolating valve, the flow of fluid through the secondary fluid conduit bypassing the pressure reducing valve. The secondary fluid conduit is fitted with at least one rotatable turbine, a third isolating valve upstream, and a fourth isolating valve downstream. Under the influence of the fluid flowing through the secondary fluid conduit, each turbine can rotate to drive an electricity generator.

### CROSS-REFERENCE TO RELATED APPLICATIONS

This application is a continuation-in-part of U.S. patent application Ser. No. 12/919,297, filed Aug. 25, 2010, which is a National Stage filing of International Patent Application No. PCT/IB2009/000277, filed Feb. 17, 2009, which claims the benefit of South African Patent Application No. 2008/01762 filed Feb. 25, 2008. The contents of the aforementioned applications are hereby incorporated by reference in their entirety.

### FIELD OF THE INVENTION

This invention relates to an electricity generating arrangement.

### BACKGROUND OF THE INVENTION

There are many different ways of generating electricity. With the ever-growing shortage of natural resources, there is a continuous need of finding alternative ways of generating electricity. The well-known alternative ways make use of water, solar energy or wind to ultimately generate electricity. Each of these options have their disadvantages, with cost and long timeframes for installing and commissioning the associated equipment making these alternative ways not feasible in situations where electricity is needed urgently.

### SUMMARY OF THE INVENTION

It is therefore an aim of the present invention to provide an arrangement that makes use of flowing water to generate electricity, but that is relatively quick, easy and inexpensive to setup.

According to a first aspect of the invention there is provided an electricity generating arrangement comprising:
at least one secondary water conduit fitted to a primary water conduit, the secondary water conduit defining an inlet for allowing water flowing through the primary water conduit to enter the secondary water conduit and an outlet for allowing water flowing through the secondary water conduit to exit the secondary water conduit so as to rejoin the primary water conduit; and
at least one rotatable turbine located within the secondary water conduit, each turbine being connectable to a generator so that under the influence of the water flowing through the secondary water conduit, the turbine can rotate so as to drive the generator to generate electricity.

In an example embodiment, an inlet valve is located within the secondary water conduit, adjacent the inlet, and an outlet valve is located within the secondary water conduit, adjacent the outlet.

In an example embodiment, the secondary water conduit comprises a substantially elongate portion that runs substantially parallel to the primary water conduit.

In an example embodiment, the turbine comprises either a fin arrangement or a threaded screw.

In an example embodiment, the primary water conduit is part of a residential/municipal water distribution system.

In an alternate example embodiment, the primary water conduit is defined by a natural conduit carrying water, such as a river.

According to a second aspect of the invention there is provided a method of fitting an electricity generating arrangement to a primary water conduit, the method comprising:
stopping the flow of water through the primary water conduit;
defining an outlet and an inlet in a side wall of the primary water conduit; and
fitting a secondary water conduit to the primary water conduit, the secondary water conduit defining an inlet that can be in fluid communication with the outlet defined in the primary water conduit, the secondary water conduit defining an outlet that can be in fluid communication with the inlet defined in the primary water conduit, the secondary water conduit housing a rotatable turbine, the turbine being connectable to a generator,
   so that water flowing through the primary water conduit can enter the secondary water conduit, flow through the secondary water conduit and exit the secondary water conduit so as to rejoin the primary water conduit, so that under the influence of the water flowing through the secondary water conduit, the turbine can rotate so as to drive the generator to generate electricity.

In an example embodiment, the method includes fitting an inlet valve within the secondary water conduit, adjacent its inlet, and fitting an outlet valve within the secondary water conduit, adjacent its outlet.

According to a third aspect of the invention there is provided a method of fitting an electricity generating arrangement to a primary water conduit, the primary water conduit comprising a pressure reducing valve, the method comprising:
stopping the flow of water through the primary water conduit; and
replacing the pressure reducing valve within the primary water conduit with a rotatable turbine, the turbine being connectable to a generator, so that water flowing through the primary water conduit can drive the generator to generate electricity.

In an example embodiment, the method includes fitting the pressure reducing valve adjacent the primary water conduit, in parallel with the rotatable turbine.

According to a fourth aspect of the invention there is provided an electricity generating arrangement comprising;
at least one secondary fluid conduit fitted to a primary fluid conduit, the primary fluid conduit being fitted with:
a pressure reducing valve;
a first isolating valve upstream of the pressure reducing valve; and
a second isolating valve downstream of the pressure reducing valve,
the secondary fluid conduit defining an inlet, before the first isolating valve, for allowing fluid flowing through the primary fluid conduit to enter the secondary fluid conduit, when the first isolating valve is closed, so as to define a default, bypass mode in which all the fluid flows through the secondary fluid conduit, and an outlet for allowing fluid flowing through the secondary fluid conduit to exit the secondary fluid conduit so as to rejoin the primary fluid conduit after the second isolating valve, the flow of fluid through the secondary fluid conduit thus bypassing the pressure reducing valve of the primary fluid conduit when the first isolating valve is closed, the secondary fluid conduit being fitted with:
   at least one rotatable turbine;
   a third isolating valve upstream of the turbine; and
   a fourth isolating valve downstream of the turbine, and
a generator, each turbine being connected to the generator so that under the influence of the fluid flowing through the secondary fluid conduit, the turbine can rotate so as to drive the generator to generate electricity.

In an embodiment, the bypass mode, the pressure reducing valve and the second isolating valve are both closed.

In an embodiment, in the bypass mode, the third and fourth isolating valves are both opened, so as to define a high pressure zone upstream of the turbine and a low pressure zone downstream of the turbine.

In an embodiment, a non-bypass mode can be defined when required by closing the third and fourth isolating valves so that all the fluid flows through the primary fluid conduit.

In an embodiment, in the non-bypass mode, the first and second isolating valves are both opened, and the pressure reducing valve is also opened, so as to define a high pressure zone upstream of the pressure reducing valve and a low pressure zone downstream of the pressure reducing valve.

In an embodiment, the primary fluid conduit is an oil conduit, with the fluid accordingly taking the form of oil.

In an embodiment, the primary fluid conduit is part of a residential/municipal water distribution system, with the fluid accordingly taking the form of water.

In an embodiment, the primary fluid conduit is defined by a natural conduit carrying water.

In an embodiment, the turbine comprises either a fin arrangement or a threaded screw.

According to a fifth aspect of the invention there is provided a method of operating an electricity generating arrangement comprising:
stopping the flow of fluid through a primary fluid conduit, the primary fluid conduit including a pressure reducing valve, a first isolating valve upstream of the pressure reducing valve, and a second isolating valve downstream of the pressure reducing valve,
defining an outlet and an inlet in a side wall of the primary fluid conduit, on opposite sides of the first and second isolating valves, respectively;
fitting a secondary fluid conduit to the primary fluid conduit, the secondary fluid conduit defining an inlet, before the first isolating valve, for allowing fluid flowing through the primary fluid conduit to enter the secondary fluid conduit, when the first isolating valve is closed, so as to define a default, bypass mode in which all the fluid flows through the secondary fluid conduit, and an outlet for allowing fluid flowing through the secondary fluid conduit to exit the secondary fluid conduit so as to rejoin the primary fluid conduit after the second isolating valve, the flow of fluid through the secondary fluid conduit thus bypassing the pressure reducing valve of the primary fluid conduit when the first isolating valve is closed, the secondary fluid conduit being fitted with at least one rotatable turbine, a third isolating valve upstream of the turbine, and a fourth isolating valve downstream of the turbine, and
connecting a generator to the at least one turbine, each turbine being connected to the generator so that under the influence of the fluid flowing through the secondary fluid conduit, the turbine can rotate so as to drive the generator to generate electricity.

In an embodiment, in the bypass mode, the method includes closing the pressure reducing valve and the second isolating valve.

In an embodiment, in the bypass mode, the method includes opening the third and fourth isolating valves, so as to define a high pressure zone upstream of the turbine and a low pressure zone downstream of the turbine.

In an embodiment, a non-bypass mode can be defined when required by closing the third and fourth isolating valves so that all the fluid flows through the primary fluid conduit.

In an embodiment, in the non-bypass mode, the method comprises opening the first and second isolating valves, and opening the pressure reducing valve, so as to define a high pressure zone upstream of the pressure reducing valve and a low pressure zone downstream of the pressure reducing valve.

### BRIEF DESCRIPTION OF THE DRAWINGS

FIG. 1 shows a schematic top view of an electricity generating arrangement according to a first example embodiment of the present invention;

FIG. 2 shows a schematic view of the arrangement shown in FIG. 1 connected to a reticulation grid;

FIG. 3 shows a flow chart representing a method of fitting an electricity generating arrangement to a primary water conduit, according to a first example embodiment;

FIG. 4 shows a schematic top view of an electricity generating arrangement according to a second example embodiment of the present invention;

FIG. 5 shows a schematic top view of an electricity generating arrangement according to a third example embodiment of the present invention;

FIG. 6 shows a flow chart representing a method of fitting an electricity generating arrangement to a primary water conduit, according to a second example embodiment; and

FIGS. 7A and 7B show schematic views of an electricity generating arrangement according to a further example embodiment of the present invention.

While the invention is susceptible to various modifications and alternative forms, a specific embodiment thereof has been shown by way of example in the drawings and will herein be described in detail. It should be understood, however, that it is not intended to limit the invention to the particular forms disclosed, but on the contrary, the intention is to cover all modifications, equivalents, and alternatives falling within the spirit of the invention.

### DESCRIPTION OF PREFERRED EMBODIMENTS

Referring first to FIG. 1, an electricity generating arrangement 10 comprises a secondary water conduit 12, typically in the form of a pipe, fitted to a primary water conduit 14, which, again, is typically also in the form of a pipe. The secondary water pipe 12 defines an inlet 16 for allowing water flowing through the primary water pipe 14 to enter the secondary water pipe 12.

The secondary water pipe 12 further defines an outlet 18 for allowing water flowing through the secondary water pipe 12 to exit the secondary water pipe 12 so as to rejoin the primary water pipe 14, as indicated by the arrows in the figure.

The primary water pipe 14 typically includes a pressure reducing valve 20, as is well known in the art.

Significantly, a rotatable turbine 22 is located within the secondary water pipe 12, the turbine 20 being connectable to a generator 24 so that under the influence of the water flowing through the secondary water pipe 12, the turbine 22 can rotate so as to drive the generator 24 to generate electricity for distribution or storage.

In an example embodiment, an inlet valve 26 is located within the secondary water pipe 12, adjacent the inlet 16, and an outlet valve 28 is located within the secondary water pipe 12, adjacent the outlet 18. The valves 26, 28 may take the form of a non return valve and/or pressure reducing valve, depending on a number of factors, such as the size of supply and location, the water pressure and the anticipated water flow speed.

In addition, although not shown in FIG. 1, one or more booster pumps may be fitted, if and when needed.

In an example embodiment, the secondary water pipe 12 comprises a substantially elongate portion 30 that runs substantially parallel to the primary water pipe 14.

In an example embodiment, the turbine 22 comprises either a fin arrangement or a threaded screw.

In an example embodiment, the primary water pipe 14 is part of a residential/municipal water pipe system.

In an alternate example embodiment, the primary water pipe is defined by a natural conduit carrying water, such as a river. In this embodiment, pumps may be fitted to pump the water out of the river, through the secondary water pipe, and then back into the river.

Turning now to FIG. 2, the relationship between the electricity generating arrangement 10 shown in FIG. 1 and an electrical reticulation grid or network is shown. FIG. 2 shows the secondary water pipe 12, turbine 22 and generator 24, as described above. The generator 24 may be housed within a suitable power station 42, with connection cables 44 extending from the generator 24 to a transformer station 46. From the transformer station 46, overhead cables 48 connect the transformer station 46 to a mast 50, and then from the mast 50 to another transformer station 52. A further overhead cable 54 may carry the electricity to another mast 56, which can then further distribute the electricity as needed.

Alternatively, or in addition, underground cables 58, 60 may also be used to carry the electricity to a transformer station 46 or 52, and then onto a mini substation or directly to a consumer. Clearly, the reticulation network may be designed in any one of a number of well-known ways, with the grid shown in FIG. 3 representing only one illustrative way of doing this.

Turning now to FIG. 3, a method 70 of fitting an electricity generating arrangement to a primary water pipe will be described. This method 70 comprises stopping the flow of water through the primary water pipe, as indicated by block 72. The method 70 then comprises defining an outlet and an inlet in a side wall of the primary water pipe, as indicated by block 74. The method 70 concludes by fitting a secondary water pipe to the primary water pipe, as indicated by block 76.

As described above, the secondary water pipe defines an inlet that can be in fluid communication with the outlet defined in the primary water pipe. The secondary water pipe further defines an outlet that can be in fluid communication with the inlet defined in the primary water pipe. The secondary water pipe houses a rotatable turbine, the turbine being connectable to a generator, so that water flowing through the primary water pipe can enter the secondary water pipe, flow through the secondary water pipe and exit the secondary water pipe so as to rejoin the primary water pipe, so that under the influence of the water flowing through the secondary water pipe, the turbine can rotate so as to drive the generator to generate electricity.

In an example embodiment, although not shown in FIG. 3, the method includes fitting an inlet valve within the secondary water pipe, adjacent its inlet, and fitting an outlet valve within the secondary water pipe, adjacent its outlet.

Turning now to FIG. 4, a variation of the electricity generating arrangement 10 shown in FIG. 1 is disclosed, in which a plurality of turbines and generators is provided. In particular, an electricity generating arrangement 80 comprises a main secondary water conduit 82, typically in the form of a pipe, fitted to a primary water conduit 84, which, again, is typically also in the form of a pipe.

The main secondary water pipe 82 defines an inlet 86 for allowing water flowing through the primary water pipe 84 to enter the main secondary water pipe 82. The main secondary water pipe 82 further defines an outlet 88 for allowing water flowing through the main secondary water pipe 82 to exit the main secondary water pipe 82 so as to rejoin the primary water pipe 84, as described above.

The primary water pipe 84 typically includes a pressure reducing valve 90, as is well known in the art.

Significantly, a plurality of additional secondary water conduits 92, 94 extend across the ends of the main secondary water pipe 82 so as to define a parallel arrangement of secondary water pipes 82, 92 and 94.

Rotatable turbines 96, 98 and 100 are located within the secondary water pipes 82, 92 and 94, respectively. Each turbine 96, 98 and 100 is connectable to a generator 102, 104 and 106 so that under the influence of the water flowing through the secondary water pipes 82, 92 and 94 the turbines 96, 98 and 100 can rotate so as to drive the generators 102, 104 and 106 to generate electricity. The generated electricity may either be distributed locally via a local cable distribution network, as indicated by arrow 108, or the voltage may be stepped up using suitable transformers 110 for long distance distribution over a high voltage network, as indicated by arrow 112.

In a further version of the invention, turning now to FIG. 5, an electricity generating arrangement 120 comprises replacing a pressure reducing valve, which is typically fitted within a primary water conduit 122, with a rotatable turbine 124. The turbine 124 may then in turn be connected to a generator 126, so that water flowing through the primary water conduit can drive the generator 126 to generate electricity. As described above, the generated electricity may either be distributed locally via a local cable distribution network, as indicated by arrow 128, or the voltage may be stepped up using suitable transformers 130 for long distance distribution over a high voltage network, as indicated by arrow 132.

A pressure reducing valve 134 may be fitted adjacent the primary water conduit 122, so as to be substantially in parallel with the rotatable turbine 124.

In one version of the embodiment shown in FIG. 5, a secondary/by-pass may be fitted in parallel with the primary water conduit 122, for use when the turbine 124 is not operational.

Turning now to FIG. 6, which is related to the arrangement shown in FIG. 5, a further aspect of the present invention provides a method 140 of fitting an electricity generating arrangement to a primary water conduit, the primary water conduit comprising a pressure reducing valve. The method 140 comprises stopping the flow of water through the primary water conduit, as indicated by block 142, and then replacing the pressure reducing valve within the primary water conduit with a rotatable turbine. As described above, the turbine is connectable to a generator, so that water flowing through the primary water conduit can drive the generator to generate electricity.

Although not shown in FIG. 6, the method 140 may further include fitting the pressure reducing valve adjacent the primary water conduit, in parallel with the rotatable turbine.

Since it is envisaged that the primary water pipe will form part of a residential/municipal water pipe system, the present invention discloses an electricity generating arrangement that is relatively quick, easy and inexpensive to setup.

Turning now to FIGS. 7A and 7B, a further embodiment of the present invention will be described. In this embodiment, an electricity generating arrangement 150 comprises at least one secondary fluid conduit 152 fitted to a primary fluid conduit 154. The primary fluid conduit 154 is fitted with a pressure reducing valve 156, a first isolating valve 158 upstream of the pressure reducing valve 156, and a second isolating valve 160 downstream of the pressure reducing valve 156.

Regarding the isolating valves 158, 160, these valves serve to isolate certain sections of the fluid (water, gas and oil) network. These valves stop fluids from flowing through a pipe if the valve is closed. This will normally be done for maintenance purposes or for excluding a certain section of the fluid network. These valves typically include a disc that moves up or down, when a connected handle is turned, and will open or shut the valve either to stop fluid from passing through the valve or to allow fluid to pass through the valve. Isolation valves thus have no effect on the fluid speed or pressure in the pipe.

A pressure reducing valve (PRV), such as valve 156, on the other hand, serves to reduce/regulate the fluid pressure at certain positions within a piped network. This type of valve is also known as a pressure release valve or a pressure regulating valve. The downstream pressure in the pipe will thus be lower than the upstream pressure. The PRV will be calibrated to reduce the upstream pressure to the required downstream pressure.

The secondary fluid conduit 152 defines an inlet 162, proximate a junction connection, before the first isolating valve 158, for forcing fluid flowing through the primary fluid conduit 154 to enter the secondary fluid conduit 152, when the first isolating valve 158 is closed, as indicated by bypass arrow 163, so as to bypass the pressure reducing valve 156, so as to define a default, bypass mode in which all the fluid flows through the secondary fluid conduit 152.

The isolating valves 158, 160 and the pressure reducing valve 156 may be operated either manually or may be connected to an electronic controller to control the operation of the valve, typically remotely.

The secondary fluid conduit 152 further defines an outlet 164 for allowing fluid flowing through the secondary fluid conduit 152 to exit the secondary fluid conduit 152 so as to rejoin the primary fluid conduit 154 after the second isolating valve 160, the flow of fluid through the secondary fluid conduit 152 thus bypassing the pressure reducing valve 156 of the primary fluid conduit 154 when the first isolating valve 158 is closed (when in the bypass mode). The configuration of the connection at the outlet 164 may vary, depending on the layout of the primary fluid conduit 154 at the specific location.

The secondary fluid conduit 152 is fitted with a rotatable turbine 166, a third isolating valve 168 upstream of the turbine 166, and a fourth isolating valve 170 downstream of the turbine 166.

The electricity generating arrangement 150 further comprises a generator 172, the turbine 166 being connected to the generator 172 so that under the influence of the fluid flowing through the secondary fluid conduit 152, the turbine 166 can rotate so as to drive the generator 172 to generate electricity.

In the bypass mode, as shown in FIG. 7B, the pressure reducing valve 156 and the second isolating valve 160 are both closed.

In an embodiment, the turbine 166 will be calibrated to reduce the pressure within the secondary fluid conduit 152 to roughly the same pressure as per the downstream pressure of the primary fluid conduit 154, after the pressure reducing valve 156. The upstream fluid pressure of the turbine 166 and the pressure reducing valve 156 will be exactly the same and the downstream pressure of the secondary fluid conduit 152, after the turbine 166, will be roughly the same as the downstream pressure of the primary fluid conduit 154, after the pressure reducing valve. In an embodiment, the jets within the turbine 166 may be calibrated to spray fluid on the turbine blades to cause it to turn. The amount of fluid that will be forced onto the blades will vary, depending on the final pressure required downstream from the turbine 166.

In addition, in the bypass mode, the third and fourth isolating valves 168, 170 are both opened, so as to define a high pressure zone 174 upstream of the turbine 166 and a low pressure zone 176 downstream of the turbine 166. The turbine 166 thus essentially acts a pressure reducing valve within the secondary fluid conduit 152, to reduce the pressure in the conduit 152 to allow the fluid to rejoin the primary fluid conduit 154.

The significance of the default bypass mode is to ensure that fluid does not flow simultaneously through both the primary fluid conduit 154 and the secondary fluid conduit 152. There are a number of reasons why this is important, as follows:
a) To extract the optimal amount of energy from the fluid to turn the turbine 166, all the fluid must flow through the secondary fluid conduit 152. If the fluid flows through both the primary and secondary conduits 154, 152, the amount of fluid to turn the turbine 166 will be halved, thus not making the generation of electricity feasible.
b) Also, in such a case it will be very difficult to calibrate both the turbine 166 and the pressure reducing valve 156, to have the same downstream pressure and flow speed. Both downstream pressures must be the same as to allow the fluid to rejoin the primary conduit 154. If the pressure and flow speed, in either of the two conduits 152, 154 is higher than the other pipe, the fluid from the lower pressure pipe will not be able to rejoin the fluid flowing in the higher pressure conduit. This will cause the components within the lower pressure conduit to stop working normally.

The aim of the present invention is thus to provide a secondary or by-pass pipe to install a turbine to generate electricity.

A non-bypass mode, as shown in FIG. 7A, can be defined when required, for example for maintenance purposes on the secondary fluid conduit 152. This may be achieved by closing the third and fourth isolating valves 168, 170 so that all the fluid flows through the primary fluid conduit 154, as indicated by arrow 177. The upstream isolating valve 168 will stop the fluid from flowing through the turbine 166, when it is closed, and the downstream isolating valve 170 will stop fluid from the primary fluid conduit 154 to flow into the secondary fluid conduit 152 when, for example, the turbine 166 is removed for maintenance purposes. The same applies for the pressure reducing valve 156, namely an upstream isolating valve 158 and a downstream isolating valve 160.

When in the non-bypass mode, the first and second isolating valves 158, 160 are both opened, and the pressure reducing valve 156 is also opened, so as to define a high pressure zone 178 upstream of the pressure reducing valve 156 and a low pressure zone 180 downstream of the pressure reducing valve 156.

In one application, the primary fluid conduit 154 is an oil conduit, with the fluid accordingly taking the form of oil.

In an alternate application, the primary fluid conduit 154 is part of a residential/municipal water distribution system, with the fluid accordingly taking the form of water.

In yet a further application, the primary fluid conduit 154 is defined by a natural conduit carrying water.

The turbine 166 may be of the type described above i.e. comprising either a fin arrangement or a threaded screw.

The present invention extends to a related method of operating an electricity generating arrangement of the type shown in FIG. 7B. The method comprises stopping the flow of fluid through the primary fluid conduit 154, the primary fluid conduit 154 including a pressure reducing valve 156, a first isolating valve 158 upstream of the pressure reducing valve 156, and a second isolating valve 160 downstream of the pressure reducing valve 156.

The method then comprises defining an outlet and an inlet in a side wall of the primary fluid conduit 154, on opposite sides of the first and second isolating valves 158, 160, respectively.

A secondary fluid conduit 152 is then fitted to the primary fluid conduit 154, the secondary fluid conduit 152 defining an inlet 162, before the first isolating valve 158, for allowing fluid flowing through the primary fluid conduit 154 to enter the secondary fluid conduit 152, when the first isolating valve 158 is closed. This defines a default, bypass mode in which all the fluid flows through the secondary fluid conduit 152, and an outlet 164 for allowing fluid flowing through the secondary fluid conduit 152 to exit the secondary fluid conduit 152 so as to rejoin the primary fluid conduit 154 after the second isolating valve 160. The flow of fluid through the secondary fluid conduit 152 thus bypasses the pressure reducing valve 156 of the primary fluid conduit 154 when the first isolating valve 158 is closed. The secondary fluid conduit 152 is fitted with a rotatable turbine 166, a third isolating valve 168 upstream of the turbine 166, and a fourth isolating valve 170 downstream of the turbine 166.

The method further comprises connecting a generator 172 to the turbine 166, the turbine 166 being connected to the generator 172 so that under the influence of the fluid flowing through the secondary fluid conduit 152, the turbine 166 can rotate so as to drive the generator 172 to generate electricity.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention. It is also contemplated that additional embodiments according to aspects of the present invention may combine any number of features from any of the embodiments described herein.

What is claimed is:

1. An electricity generating arrangement comprising;
at least one secondary fluid conduit fitted to a primary fluid conduit, the primary fluid conduit being fitted with:
a pressure reducing valve;
a first isolating valve upstream of the pressure reducing valve; and
a second isolating valve downstream of the pressure reducing valve,
the secondary fluid conduit defining an inlet, before the first isolating valve, for allowing fluid flowing through the primary fluid conduit to enter the secondary fluid conduit, when the first isolating valve is closed, so as to define a default, bypass mode in which all the fluid flows through the secondary fluid conduit, and an outlet for allowing fluid flowing through the secondary fluid conduit to exit the secondary fluid conduit so as to rejoin the primary fluid conduit after the second isolating valve, the flow of fluid through the secondary fluid conduit thus bypassing the pressure reducing valve of the primary fluid conduit when the first isolating valve is closed, the secondary fluid conduit being fitted with:
at least one rotatable turbine;
a third isolating valve upstream of the turbine; and
a fourth isolating valve downstream of the turbine, and
a generator, each turbine being connected to the generator so that under the influence of the fluid flowing through the secondary fluid conduit, the turbine can rotate so as to drive the generator to generate electricity.

2. The electricity generating arrangement of claim 1, wherein in the bypass mode, the pressure reducing valve and the second isolating valve are both closed.

3. The electricity generating arrangement of claim 1, wherein in the bypass mode, the third and fourth isolating valves are both opened, so as to define a high pressure zone upstream of the turbine and a low pressure zone downstream of the turbine.

4. The electricity generating arrangement of claim 3, wherein a non-bypass mode can be defined when required by closing the third and fourth isolating valves so that all the fluid flows through the primary fluid conduit.

5. The electricity generating arrangement of claim 4, wherein in the non-bypass mode, the first and second isolating valves are both opened, and the pressure reducing valve is also opened, so as to define a high pressure zone upstream of the pressure reducing valve and a low pressure zone downstream of the pressure reducing valve.

6. The electricity generating arrangement of claim 4, wherein the turbine is calibrated to reduce the pressure within the secondary fluid conduit, in the bypass mode, to approximately the same pressure as the downstream pressure of the primary fluid conduit, after the pressure reducing valve, in the non-bypass mode.

7. The electricity generating arrangement of claim 1, wherein the primary fluid conduit is an oil conduit, with the fluid accordingly taking the form of oil.

8. The electricity generating arrangement of claim 1, wherein the primary fluid conduit is part of a residential/municipal water distribution system, with the fluid accordingly taking the form of water.

9. The electricity generating arrangement of claim 8, wherein the primary fluid conduit is defined by a natural conduit carrying water.

10. The electricity generating arrangement of claim 1, wherein the turbine comprises either a fin arrangement or a threaded screw.

11. A method of operating an electricity generating arrangement comprising:
stopping the flow of fluid through a primary fluid conduit, the primary fluid conduit including a pressure reducing valve, a first isolating valve upstream of the pressure reducing valve, and a second isolating valve downstream of the pressure reducing valve,
defining an outlet and an inlet in a side wall of the primary fluid conduit, on opposite sides of the first and second isolating valves, respectively;
fitting a secondary fluid conduit to the primary fluid conduit, the secondary fluid conduit defining an inlet, before the first isolating valve, for allowing fluid flowing through the primary fluid conduit to enter the secondary fluid conduit, when the first isolating valve is closed, so as to define a default, bypass mode in which all the fluid flows through the secondary fluid conduit, and an outlet for allowing fluid flowing through the secondary fluid conduit to exit the secondary fluid conduit so as to rejoin the primary fluid conduit after the second isolating valve, the flow of fluid through the secondary fluid conduit thus bypassing the pressure reducing valve of the primary fluid conduit when the first isolating valve is closed, the secondary fluid conduit being fitted with at least one rotatable turbine, a third isolating valve upstream of the turbine, and a fourth isolating valve downstream of the turbine, and
connecting a generator to the at least one turbine, each turbine being connected to the generator so that under the influence of the fluid flowing through the secondary fluid conduit, the turbine can rotate so as to drive the generator to generate electricity.

12. The method of claim 11, wherein in the bypass mode, the method includes closing the pressure reducing valve and the second isolating valve.

13. The method of claim 11, wherein in the bypass mode, the method includes opening the third and fourth isolating valves, so as to define a high pressure zone upstream of the turbine and a low pressure zone downstream of the turbine.

14. The method of claim 11, wherein a non-bypass mode can be defined when required by closing the third and fourth isolating valves so that all the fluid flows through the primary fluid conduit.

15. The method of claim 14, wherein in the non-bypass mode, the method comprises opening the first and second isolating valves, and opening the pressure reducing valve, so as to define a high pressure zone upstream of the pressure reducing valve and a low pressure zone downstream of the pressure reducing valve.
